(19) United States
(12) Patent Application Publication
(10) Pub. No.: US 2014/0270330 A1
(43) Pub. Date: Sep. 18, 2014

(54) METHOD AND APPARATUS FOR EMBEDDING AND DETECTING WATERMARK

(71) Applicants: Sergey POMETUN, Kyiv (UA); Dmitriy DOROGOVTSEV, Kiev (UA); Maksym KOSHEL, Kiev (UA); Nikolay POLYANOVSKIY, Kiev (UA); Svitlana VOLKOVA, Kyiv (UA)

(72) Inventors: Sergey POMETUN, Kyiv (UA); Dmitriy DOROGOVTSEV, Kiev (UA); Maksym KOSHEL, Kiev (UA); Nikolay POLYANOVSKIY, Kiev (UA); Svitlana VOLKOVA, Kyiv (UA)

(73) Assignee: SAMSUNG ELECTRONICS CO., LTD., Suwon-si (KR)

(21) Appl. No.: 13/837,415

(22) Filed: Mar. 15, 2013

(51) Int. Cl. G06T 1/00

(52) U.S. Cl. CPC G06T 1/0021
USPC 382/100

(57) ABSTRACT

A method of embedding a watermark in video data includes generating a watermark to be embedded in the video data, generating a bit string based on a generated watermark, and embedding a watermark in the video data by changing a quantization parameter of the video data by a predetermined value based on the bit string.

### CROSS-REFERENCE TO RELATED PATENT APPLICATION

This application claims the benefit of Korean Patent Application No. 10-2012-0029410, filed on Mar. 22, 2012, in the Korean Intellectual Property Office, the disclosure of which is incorporated herein in its entirety by reference.

### BACKGROUND

1. Field

Methods and apparatuses consistent with exemplary embodiments relate to a method and apparatus for embedding and detecting a watermark, and more particularly, to a method and apparatus of embedding a watermark in video data easily by changing some parameters in the video data and detecting a watermark from video data in which the watermark is embedded.

2. Description of the Related Art

Digital video apparatuses employ compression technologies such as MPEG-2, MPEG-24, or H.264/MPEG-4, Part 10, or advanced video coding (AVC) to efficiently transmit and receive digital video. The video compression technologies perform estimation of space and time to reduce or remove redundancy existing in video sequences.

In block based video compression technologies, video blocks may include luma (luminance) blocks and chroma (chrominance) blocks. For example, a 16×16 block of pixels may be expressed by four 8×8 luma blocks and two 8×8 chroma blocks. A Y, Cb, and Cr color space is generally used for video coding. Y denotes a luma component, Cb denotes a blue chroma component, and Cr denotes a red chroma component.

Conventionally, to embed a watermark in video data, a code that may be mechanically read is embedded in video data. In this case, however, it is a problem that, when a process of correcting data such as compression of video data is performed, information about a watermark embedded in the video data may be distorted. Also, when a large amount of watermark information is embedded in video data to prevent distortion of watermark information, distortion of video data becomes serious so that a user viewing the video data may recognize that the video data is distorted.

U.S. Patent Application Publication No. 2005/0265576 A1 discloses a video watermarking method and apparatus, in which a watermark is embedded by determining the strength of embedding a watermark of a scene unit by calculating complexity of an image of video data. However, it is a problem that an overall image processing is complicated because complexity of an image is calculated for each scene. Thus, to address the problem, there is demand for a method by which: an embedded watermark may be easily detected, a user may not recognize an embedded watermark in video data, and a watermark may be simply embedded and detected.

### SUMMARY

Exemplary embodiments provide a method and apparatus of simply embedding a watermark in video data by changing a quantization parameter of the video data.

Exemplary embodiments provide a method and apparatus for detecting a watermark embedded in video data by determining whether a quantization parameter of the video data where the watermark is embedded is changed.

According to an aspect of exemplary embodiments, a method of embedding a watermark in video data includes generating a watermark to be embedded in the video data, generating a bit string based on a generated watermark, and embedding a watermark in the video data by changing a quantization parameter of the video data by a predetermined value based on the bit string.

The embedding of a watermark may include dividing the video data into a plurality of areas having a predetermined size and changing a value of a quantization parameter corresponding to the plurality of areas to allow a bit included in the bit string to correspond to one of the plurality of areas.

One of the plurality of areas may be a pixel block having a predetermined number of pixels and belonging to a predetermined number of one or more continuous frames in a group of pictures.

The quantization parameter may be a quantization parameter of a chroma component of the video data.

The embedding of a watermark may include changing an offset value of the quantization parameter.

The embedding of a watermark may include changing a quantization parameter by decreasing the quantization parameter.

The embedding of a watermark may include changing a plurality of quantization parameters to correspond to a plurality of bits in the bit string.

According to another aspect of exemplary embodiments, there is provided a computer-readable recording medium having recorded thereon a program for executing the method of embedding a watermark of any one of the above-described methods.

According to another aspect of exemplary embodiments, a method of detecting a watermark embedded in video data comprises determining whether a quantization parameter is changed in the video data where the watermark is embedded, deciding a bit string based on the determination, and restoring the watermark from a generated bit string.

In the determining of whether a quantization parameter is changed, the video data where the watermark is embedded may be divided into a plurality of areas having a predetermined size and whether the quantization parameter of each of the plurality of areas is changed is determined.

One of the plurality of areas may be a pixel block having a predetermined number of pixels and belonging to a predetermined number of one or more continuous frames in a group of pictures.

The quantization parameter may be a quantization parameter of a chroma component of the video data.

The determining of whether the quantization parameter is changed may include determining whether an offset value of the quantization parameter is changed.

The determining of whether the quantization parameter is changed may include comparing the video data where a watermark is embedded with the original video data and the video data where a watermark is embedded with video data where a quantization parameter of the original video data is changed, and determining whether a quantization parameter is changed based on a result of the comparisons.

The video data where the quantization parameter of the original video data may be obtained by decreasing the quantization parameter.

The determining of whether the quantization parameter is changed may include determining whether a plurality of quantization parameters are changed.

According to another aspect of an exemplary embodiment, there is provided a computer-readable recording medium having recorded thereon a program for executing the method of detecting a watermark of any one of the above-described methods.

According to another aspect of an exemplary embodiment, an apparatus for embedding a watermark in video data includes a watermark generator which generates a watermark to be embedded in the video data, an encoder which generates a bit string based on a watermark generated by the watermark generator, and a watermark embedder which embeds a generated bit string in the video data by chaining a quantization parameter of the video data by a predetermined value.

According to another aspect of an exemplary embodiment, an apparatus for detecting a watermark embedded in video data includes a determination unit which determines whether a quantization parameter is changed in the video data where the watermark is embedded, a bit string generator which generates a bit string based on the determination of the determination unit, and a decoder which generates a watermark from a generated bit string.

### BRIEF DESCRIPTION OF THE DRAWINGS

The above and other features of exemplary embodiments will become more apparent by describing in detail the exemplary embodiments with reference to the attached drawings in which:

FIG. 1 is a flowchart for explaining a process of embedding a watermark in video data according to an exemplary embodiment;

FIG. 2 is a flowchart for explaining a process of detecting a watermark from video data where the watermark is embedded according to an exemplary embodiment;

FIG. 3 is a block diagram schematically illustrating a structure of a watermark embedding apparatus for embedding a watermark in video data according to an exemplary embodiment;

FIG. 4 is a block diagram schematically illustrating a structure of a watermark detection apparatus for detecting a watermark from video data where the watermark is embedded according to an exemplary embodiment;

FIG. 5 is a block diagram schematically illustrating a structure of a determination unit of a watermark detection apparatus according to an exemplary embodiment;

FIG. 6 is a view schematically illustrating a method of dividing video data into a plurality of areas having a predetermined size according to an exemplary embodiment; and

FIG. 7 illustrates an exemplary embodiment.

### DETAILED DESCRIPTION OF EXEMPLARY EMBODIMENTS

The attached drawings for illustrating exemplary embodiments are referred to in order to gain a sufficient understanding of the present inventive concept, the merits thereof, and some of the objectives accomplished by the implementation of the exemplary embodiments. Hereinafter, exemplary embodiments will be explained in detail with reference to the attached drawings. Like reference numerals in the drawings denote like elements. In the present specification, when a constituent element “connects” or is “connected” to another constituent element, the constituent element contacts or is connected to the other constituent element not only directly but also electrically through at least one of other constituent elements interposed therebetween. Also, when a part may “include” a certain constituent element, unless specified otherwise, it may not be construed to exclude another constituent element but may be construed to further include other constituent elements.

FIG. 1 is a flowchart for explaining a process of embedding a watermark in video data according to an exemplary embodiment. In the following description, major items of a process according to the present embodiment are described with reference to FIG. 1, whereas redundant items are described in detail with reference to FIG. 3.

First, a watermark to be embedded in video data is generated (S110). A bit string is generated based on a generated watermark (S120). Next, a watermark embedding process is performed in which a quantization parameter (QP) of video data is changed by a predetermined value based on a generated bit string (S130).

The operation S110 may include a process of generating a bit string by encoding a watermark. The operation S130 may include a process of dividing video data into a plurality of areas having a predetermined size and changing the QP of each area. The QP in the operation S130 may be a QP for a chroma component of video data. The operation S130 may include a process of changing an offset value of the QP. In the operation S130, to prevent generation of overflow as the QP increases, the QP may be changed by a decrease of the QP only without increasing the QP. In the operation S130, a plurality of QPs may be changed to correspond to a plurality of bits of the bit string generated in the operation S120.

FIG. 2 is a flowchart for explaining a process of detecting a watermark from video data where the watermark is embedded according to an exemplary embodiment. In the following description, major items of a process according to the present embodiment are described with reference to FIG. 2, whereas redundant items are described in detail with reference to FIGS. 4 and 5.

First, it is determined whether a QP is changed in the video data where a watermark is embedded (S210). A bit string is decided based on the above determination (S220). Next, a watermark may be restored from the bit string decided in the operation S220 (S230).

The operation S210 may include dividing the video data into a plurality of areas having a predetermined size and determining whether a QP is changed in each area. The QP may be a QP for a chroma component of video data. The operation S210 may include a process of determining whether an offset value of the QP is changed. The operation S210 may include comparing the video data where a watermark is embedded with the original video data and comparing the video data where a watermark is embedded with test data obtained by changing the QP of the original video data. The operation S210 may further include a process of determining whether a QP is changed based on a result of the two comparisons.

Whether a QP is changed may be determined based on a result of the comparisons between the three types of video data; that is, to which of the original video data and the video data with a changed QP, the video data where a watermark is embedded is more similar.

The operation S220 may include a process of determining a bit string according to whether a QP is changed. The bit string may be a bit string whose length is not determined. Also, in the operation S210, it is determined whether a plurality of QPs are changed so that a bit string corresponding thereto may be generated in the operation S220. In the operation S230, a watermark may be restored by decoding a generated bit string.

FIG. 3 is a block diagram schematically illustrating a structure of a watermark embedding apparatus for embedding a watermark in video data according to an exemplary embodiment. Referring to FIG. 3, a watermark generator 310 may generate information to be embedded in video data as a watermark. An encoder 320 may generate a bit string by encoding the watermark generated by the watermark generator 310. As illustrated in FIG. 3, the bit string may be a bit string whose length is not determined. A watermark embedder 330 may generate video data where a watermark is embedded, by changing a QP of the original video data corresponding to the bit string generated by the encoder 320. The watermark generator 310, encoder 320, and watermark embedder 330 may be embodied as hardware components, or as software modules, or as a combination of hardware and software.

The watermark embedder 330 may change the QP by 1 or 2, thereby preventing a person from recognizing a change in the video data. For example, a QP is increased by 1 for “0” of a bit string generated by the encoder 320, whereas a QP is decreased by 1 for “1” of a bit string generated by the encoder 320. The watermark embedder 330 may divide video data into a plurality of areas having a predetermined size to change a QP of plurality of areas such that a bit included in a bit string can correspond to an area of the plurality of areas.

One area having a predetermined size may be a pixel block having a predetermined number of pixels and belonging to a predetermined number of one or more continuous frames in a group of pictures. For example, as illustrated in FIG. 6, pixels belonging to the inside of a square corresponding to 30×30 pixels in six frames of a group of pictures (GOP) may form one pixel block.

Also, the QP of the watermark embedder 330 may be a QP of the chroma component of video data. That is, in a Y, Cr, and Cb color format, a QP of video data may be changed corresponding to a bit string by changing a QP of a Cr or Cb component. For example, in a digital video compression technology, a simplified formula of inverse scaling may be expressed as follows.

W=a*Z*2^{QP/6} [Equation 1]

In Equation 1, “W” denotes an unscaled chroma value, “Z” denotes a scaled chroma value, “QP” denotes a quantization parameter, and “a” denotes a scaling constant.

According to Equation 1, the unscaled chroma value W may be changed by decreasing the quantization parameter QP. Thus, by embedding a watermark in video data by a method of changing a QP, the video data where a watermark is embedded is compressed based on a changed chroma value so that the embedded watermark is not distorted during compression of the video data.

Also, the watermark embedder 330 may change a QP by changing an offset value of the QP. For example, a QP of the chroma component may be determined according to the following equation.

$${QP}_{I} = Clip 3 ( - {QpBdOffset}_{C} , 51 , {QP}_{Y} + {QP}_{offset} ) \\ Clip 3 ( x , y , Z ) = \{ \begin{matrix}\begin{matrix}x ; z < x \\ y ; z > y\end{matrix} \\ z ; otherwise\end{matrix} \qquad [ Equation 2 ]$$

In Equation 2, “QP_{y}” denotes a QP value of a luma component, “QP_{offset}” denotes an offset value of a QP of a chroma component, and “QpBdOffset_{C}” denotes a bit depth of a sample of chroma arrays. As it can be seen from Equation 2, a QP may be changed by changing an offset value of the QP of video data. That is, the watermark embedder 330 may embed a watermark by changing the QP_{offset} value.

Also, the watermark embedder 330 may change a QP only by a decrease of the QP without increasing the QP to prevent generation of overflow due to an increase of the QP. Also, the watermark embedder 330 may change a plurality of QPs to correspond to a plurality of bits of the bit string generated by the encoder 320. For example, a watermark may be embedded as follows by setting the QP_{offset} value of a Cb component as the first offset value of a chroma QP (hereinafter, referred to as the “chroma_qp_index_offset”) and the QP_{offset} value of a CR component as the second offset value of a chroma QP (hereinafter, referred to as the “second_chroma_qp_index_offset”).

1. Both of the chroma_qp_index_offset and the second_chroma_qp_index_offset are not changed in response to “00” of the bit string generated by the encoder 320.

2. Only the second_chroma_qp_index_offset is decreased by 1 in response to “01” of the bit string generated by the encoder 320.

3. Only the chroma_qp_index_offset is decreased by 1 in response to “10” of the bit string generated by the encoder 320.

4. The chroma_qp_index_offset and the second_chroma_qp_index_offset are each decreased by 1 in response to “11” of the bit string generated by the encoder 320.

FIG. 4 is a block diagram schematically illustrating a structure of a watermark detection apparatus 400 for detecting a watermark from video data where the watermark is embedded according to an exemplary embodiment.

A determination unit 410 may determine whether a QP is changed, by comparing the video data where a watermark is embedded with the original data thereof. The determination unit 410 is described below in detail with reference to FIG. 5.

A bit string determination unit 420 may determine a bit string according to whether a QP is changed. The bit string may be a bit string whose length is not determined. For example, assuming that it is a rule during embedding of a watermark to keep a QP without a change for “0” of a bit string and decrease a QP by 1 for “1” of a bit string, a bit string may be determined as follows. When a QP is determined to be unchanged, it is determined to be a bit “0”. When a QP is determined to be decreased by 1, it is determined to be a bit “1”. A bit string may be determined by combining the bits generated according to a result of the determination of various areas in video data.

A decoder 430 may restore a watermark by decoding the determined bit string. The determination unit 410, the bit string determination unit 420 and the decoder 430 may be embodied as hardware components, as software modules, or as a combination of hardware and software.

FIG. 5 is a block diagram schematically illustrating a structure of the determination unit 410 of a watermark detection apparatus according to an exemplary embodiment. Referring to FIG. 5, a comparison unit 510 may compare video data where a watermark is embedded, the original video data, and video data for test obtained by changing a QP in the original video data. The original video data may be included in the watermark detection apparatus 400 or obtained from a storage 530 that exists outside the watermark detection apparatus 400. The video data for test may be obtained from the storage 530 or by changing a QP of the original video data obtained from the storage 530.

Also, the comparison unit 510 compares the video data where a watermark is embedded with the original video data and the video data where a watermark is embedded with the video data for test. The comparison unit 510 may divide each video data into a plurality of areas having a size that is predetermined during embedding of a watermark and compare the respective data for each area. The comparison unit 510 may be embodied as a hardware component, as a software module, or as a combination of hardware and software.

One area having a predetermined size may be a pixel block having a predetermined number of pixels and belonging to a predetermined number of one or more continuous frames in a group of pictures.

The video data for test may be video data where all QPs of the original video data are changed in the same manner as a rule determined when a watermark is embedded. For example, during embedding of a watermark, when a QP is decreased by 1 in response to a bit 1 of the bits included in a bit string, the video data where the QPs of the original video data are changed corresponding thereto may be video data where a QP is decreased by 1 compared to the original video data.

A determination unit 520 may determine to which of the original video data and the video data for test, the video data where a watermark is embedded is more similar, as a result of the comparisons of the respective video data based on a result of the comparison by the comparison unit 510. For example, if the video data where a watermark is embedded is determined to be more similar to the original video data than the video data for test, it may be determined that a QP is not changed. On the other hand, if the video data where a watermark is embedded is determined to be more similar to the video data for test than the original video data, it may be determined that a QP is changed.

Also, the comparison unit 510 may obtain an average value of QPs of areas to be compared of the video data where a watermark is embedded, the original video data, and the video data for test. A difference between average values of the QPs of the video data where a watermark is embedded, the original video data, and the video data for test may be obtained. The determination unit 520 may determine that data in which a difference between average values of the respective QPs is relatively small is more similar to the video data where a watermark is embedded. Other statistical values such as the standard deviation may be used instead of the average value of QPs. The area to be compared may be a data area located at the same position in each data.

Also, the original video data and the video data for test may be replaced by two video data where QPs having different changed QP values are changed according to a watermark embedding method. For example, during embedding of a watermark, when a QP of video data is decreased by 1 in response to “0” of a bit string and a QP of video data is increased by 1 in response to “1” of the bit string, the original video data and the video data for test may be replaced by a first video data for test where a QP is decreased by 1 and a second video data for test where a QP is increased by 1.

Also, the QP may be a QP of a chroma component of video data. That is, the determination unit 520 may determine whether a QP of a Cr or Cb component in a Y, Cr, and Cb color space is changed according to a result of the comparison by the comparison unit 510. Also, the determination unit 520 may determine whether an offset value of a QP is changed based on a result of the comparison by the comparison unit 510.

The comparison unit 510 may divide video data into a plurality of areas having a size that is predetermined during embedding of a watermark and determine whether a QP is changed for each area. One area having a predetermined size may be a pixel block having a predetermined number of pixels and belonging to a predetermined number of one or more continuous frames in a group of pictures.

Also, the comparison unit 510 may compare video data in terms of a plurality of QPs. The determination unit 520 may determine whether the QPs are changed. The bit string determination unit 420 may determine a bit string corresponding thereto.

The comparison unit 510 may compare the original video data with each of the first video data for test where a QP of a C_{b} component is changed, the second video data for test where a QP of a C_{R} component is changed, and a third video data for test where QPs of the C_{b} and C_{R} components are changed. For example, assuming that a QP_{offset} value of a C_{b} component is “chroma_qp_index_offset” and a QP_{offset} value of a C_{R} component is “second_chroma_qp_index_offset”, the bit string determination unit 420 may determine a bit string as follows.

1. If the chroma_qp_index_offset and the second_chroma_qp_index_offset are determined to be unchanged, “00” is added to the bit string.

2. If only the chroma_qp_index_offset is determined to be decreased by 1, “01” is added to the bit string.

3. If only the second_chroma_qp_index_offset is determined to be decreased by 1, “10” is added to the bit string.

4. If both of the chroma_qp_index_offset and the second_chroma_qp_index_offset are determined to be changed, “11” is added to the bit string.

The comparison unit 510 compares the video data where a watermark is embedded with each of the video data where only the chroma_qp_index_offset is decreased by 1 in the original video data, the video data where only the second_chroma_qp_index_offset is decreased by 1 in the original video data, and the video data where both of the chroma_qp_index_offset and the second_chroma_qp_index_offset are changed.

FIG. 7 illustrates an exemplary embodiment.

According to an exemplary embodiment, when an apparatus for reproducing or storing video data reproduces video data or copies stored video data, information may be embedded in real time through a watermark in the video data.

The information embedded through a watermark may include at least one of date or time when video data is reproduced or copied, the location of an apparatus where video data is reproduced or copied, and information for identifying an apparatus for reproducing or storing video data.

According to exemplary embodiments, a watermark may be easily embedded in video data and an embedded watermark may be easily detected.

According to exemplary embodiments, a watermark may be embedded by changing a QP so that a user may not recognize that the watermark is embedded in video data.

According to exemplary embodiments, since a watermark may be easily embedded, the watermark may be embedded by including information about where and when video data is copied by an apparatus for reproducing or storing the video data. Thus, since one who uses and copies video data can be revealed, the copyright of video data may be protected.

While exemplary embodiments have been particularly shown and described, it will be understood by those skilled in the art that various changes in form and details may be made therein without departing from the spirit and scope of the invention as defined by the appended claims.

What is claimed is:

1. A method of embedding a watermark in video data, the method comprising:
generating a watermark to be embedded in the video data;
generating a bit string based on a generated watermark; and
embedding a watermark in the video data by changing a quantization parameter of the video data by a predetermined value based on the bit string.

2. The method of claim 1, wherein the embedding of a watermark comprises dividing the video data into a plurality of areas having a predetermined size and changing a value of a quantization parameter corresponding to the plurality of areas to allow a bit included in the bit string to correspond to one of the plurality of areas.

3. The method of claim 2, wherein one of the plurality of areas is a pixel block having a predetermined number of pixels and belonging to one or more continuous frames in a group of pictures.

4. The method of claim 1, wherein the quantization parameter is a quantization parameter of a chroma component of the video data.

5. The method of claim 1, wherein the embedding of a watermark comprises changing an offset value of the quantization parameter.

6. The method of claim 1, wherein the embedding of the watermark comprises changing the quantization parameter by decreasing the quantization parameter.

7. The method of claim 1, wherein the embedding of the watermark comprises changing a plurality of quantization parameters to correspond to a plurality of bits in the bit string.

8. A computer-readable recording medium having recorded thereon a program for executing the method of embedding a watermark of claim 1.

9. A method of detecting a watermark embedded in video data, the method comprising:
determining whether a quantization parameter is changed in the video data where the watermark is embedded;
determining a bit string based on the determination of whether the quantization parameter is changed in the video data where the watermark is embedded; and
restoring the watermark from a generated bit string.

10. The method of claim 9, wherein, in the determining of whether a quantization parameter is changed, the video data where the watermark is embedded is divided into a plurality of areas having a predetermined size and whether the quantization parameter of each of the plurality of areas is changed is determined.

11. The method of claim 10, wherein one of the plurality of areas is a pixel block having a predetermined number of pixels and belonging to one or more continuous frames in a group of pictures.

12. The method of claim 9, wherein the quantization parameter is a quantization parameter of a chroma component of the video data.

13. The method of claim 9, wherein the determining of whether the quantization parameter is changed comprises determining whether an offset value of the quantization parameter is changed.

14. The method of claim 9, wherein the determining of whether the quantization parameter is changed comprises comparing the video data where a watermark is embedded with the original video data and the video data where a watermark is embedded with video data where a quantization parameter of the original video data is changed; and
determining whether a quantization parameter is changed based on a result of the comparisons.

15. The method of claim 14, wherein the video data where the quantization parameter of the original video data is obtained by decreasing the quantization parameter.

16. The method of claim 9, wherein the determining of whether the quantization parameter is changed comprises determining whether a plurality of quantization parameters are changed.

17. A computer-readable recording medium having recorded thereon a program for executing the method of detecting a watermark of claim 9.

18. An apparatus for embedding a watermark in video data, the apparatus comprising:
a watermark generator which generates a watermark to be embedded in the video data;
an encoder which generates a bit string based on a watermark generated by the watermark generator; and
a watermark embedder which embeds a generated bit string in the video data by chaining a quantization parameter of the video data by a predetermined value.

19. The apparatus of claim 18, wherein the quantization parameter is a quantization parameter of a chroma component of the video data.

20. The apparatus of claim 18, wherein the watermark embedder changed an offset value of the quantization parameter.

21. The apparatus of claim 18, wherein the watermark embedder divides the video data into a plurality of areas having a predetermined size and changes a value of a quantization parameter corresponding to the plurality of areas to allow a bit included in the bit string to correspond to one of the plurality of areas.

22. An apparatus for detecting a watermark embedded in video data, the apparatus comprising:
a determination unit which determines whether a quantization parameter is changed in the video data where the watermark is embedded;
a bit string generator which generates a bit string based on the determination of the determination unit; and
a decoder which generates a watermark from a generated bit string.

23. The apparatus of claim 22, wherein the determination unit determines whether the quantization parameter is changed by comparing the video data where a watermark is embedded with the original video data and the video data where a watermark is embedded with video data where a quantization parameter of the original video data is changed.

24. The apparatus of claim 23, wherein the determination unit divides each of the video data where the watermark is embedded, the original video data, and the video data Where the quantization parameter is changed into a plurality of areas having a predetermined size and compares data for each divided area.

25. The apparatus of claim 24, wherein one of the plurality of areas is a pixel block having a predetermined number of pixels and belonging to one or more continuous frames in a group of pictures.

26. The apparatus of claim 22, wherein the quantization parameter is a quantization parameter of a chroma component of the video data.

27. The apparatus of claim 22, wherein whether the quantization parameter is changed is determined by whether an offset value of the quantization parameter is changed.
